(19) United States
(12) Patent Application Publication
(10) Pub. No.: US 2005/0005868 A1
(43) Pub. Date: Jan. 13, 2005

(54) Animal drinking water production

(76) Inventors: Allan T. Shepard, Wilmington, DE (US); Brian David Krafton, Wakefield, RI (US); Scott C. Glynn, Coventry, RI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/873,574

(22) Filed: Jun. 22, 2004

Related U.S. Application Data
(60) Provisional application No. 60/486,456, filed on Jul. 11, 2003.
(60) Provisional application No. 60/487,322, filed on Jul. 14, 2003.

(51) Int. Cl. A01K 7/00

(52) U.S. Cl. 119/72

(57) ABSTRACT

A process for producing animal drinking water is provided. The process comprises flowing water through a fluid proportioning device, which comprises three or more fluid transferring devices, to create a downstream water and to actuate the fluid transferring devices; drawing three or more compounds each from a separate source and flowing each compound separately through one of the fluid transferring devices; and injecting the compounds into the downstream water. The fluid proportioning device further comprises a conduit to the inlet of each fluid transferring device, a conduit to the outlet of each fluid transferring device, a water inlet to the device, and a water outlet from the device in which the fluid transferring device is proportionally actuated by the flow of water through the device.

This application claims the benefits of provisional application 60/486,456, 60/487,322, filed Jul. 11, 2004 and Jul. 14, 2004, respectively, the entire disclosure of which is incorporated herein by reference.

### FIELD OF THE INVENTION

This invention relates to a process for producing animal drinking water.

### BACKGROUND OF THE INVENTION

Though chlorination was carried out for the disinfection of raw water, it was discovered that when surface water is chlorinated, trihalomethanes are produced, which, such as chloroform, are reportedly carcinogenic. Many municipal water systems that exceeded 100 parts per billion maximum trihalomethane level, set by the US EPA, were required to switch to alternate disinfection systems. Disinfected water can be used for drinking water for animals such as, for example, chickens, cattle, sheep, ducks, geese, and other animals. Development of a new process for safely and efficiently producing animal drinking water would be a great contribution to the art.

### SUMMARY OF THE INVENTION

A process that can be used for producing animal drinking water is provided. The process comprises (a) flowing water through a fluid proportioning device, which comprises three or more fluid transferring devices, to create a downstream water and to actuate said fluid transferring devices; (b) drawing a metal chlorite, a metal hypochlorite, and an acid each from a separate source and flowing each separately through one of the fluid transferring devices; and (c) combining the metal chlorite, metal hypochlorite, and acid with the downstream water to produce water suitable for animal drinking.

### BRIEF DESCRIPTION OF THE DRAWINGS

FIG. 1 shows a flow diagram of an apparatus.

FIG. 2 shows the front and side of an apparatus.

### DETAILED DESCRIPTION OF THE INVENTION

A process for producing animal drinking water is disclosed. The process comprises combining one or more chemicals or compounds (hereinafter referred to as chemicals) in the water in which the compounds can be used as disinfectant or to control the pH of the water. The chemicals or compounds are a metal chlorite, a metal hypochlorite, and an acid.

Any chemicals known to one skilled in the art that can disinfect water and/or react to produce chlorine dioxide can be used and are well known in the art. Illustrated examples of a metal chlorite include an alkali metal chlorite, alkaline metal chlorite, or combinations thereof. Specific examples of metal chlorite include sodium chlorite, potassium chlorite, or combinations thereof. Similarly, a metal hypochlorite can be an alkali metal hypochlorite, alkaline metal hypochlorite, or combinations thereof. Examples of metal hypochlorite include sodium hypochlorite, potassium hypochlorite, or combinations thereof. Any mineral acid can be used. Example of such acid includes sulfuric acid, phosphoric acid, nitric acid, hydrochloric acid, or combinations thereof. The molar ratio of metal chlorite to acid can be in the range of from about 0.001:1 to about 100:1 or about 0.001:1 to about 10:1 and that of metal hypochlorite to acid can also be in the range of from about 0.001:1 to about 100:1 or about 0.001:1 to about 10:1.

Suitable chemicals can also include a metal chlorate, an oxidizing agent, and an acid. A metal chlorate can be an alkali metal chlorate, alkaline metal chlorate, or combinations thereof. Examples of metal chlorate include sodium chlorate, potassium chlorate, or combinations thereof. Any oxidizing agent such as inorganic oxidizing agent, organic oxidizing agent, or combinations thereof can be used. Examples of oxidizing agent include hydrogen peroxide, peracetic acid, oxides of nitrogen, sodium peroxide, benzoyl peroxide, m-chlorobenzoic acid, m-bromobenzoic acid, p-chlorobenzoic acid, or combinations thereof. Any acid disclosed above can be used. The molar ratio of metal chlorate to acid can be in the range of from about 0.001:1 to about 10:1 and that of oxidizing agent to acid can also be in the range of from about 0.001:1 to about 10:1.

Other chemicals include, but are not limited to, Sodium bromite, sodium hypobromite, and acid.

The chemicals can be combined, for example, by mixing with a mechanical mixer or static mixer. The production of animal water can be carried out under any suitable conditions by any methods known to one skilled in the art. It is preferred that the apparatus disclosed below be used.

The process can employ an apparatus capable of transporting three or more chemicals to a reaction medium such as, for example, water to produce a product by reaction of two or more of these compounds. The apparatus can comprise a fluid proportioning device, which comprises a water inlet; a water outlet; a main water-driven drive assembly; and a first, a second, a third, and optionally additionally fluid transferring devices. The water inlet is connectable to a water source and the fluid transferring device can comprise a transferring device inlet and a transferring device outlet, each being connectable to a conduit. The water source is capable of producing a water flow into and through the main water-driven drive assembly thereby producing a downstream water through said water outlet. Each of the fluid transferring devices is proportionally actuated by the water flow thereby withdrawing through the first, second, third, and optionally additional fluid transferring devices through which precursor chemicals are respectively drawn in a proportional amount independent of the flow rate of the water flow and discharging, for example, the precursor chemicals to said downstream water.

The fluid proportioning device can comprise an inlet end connectable to a water source with an inlet conduit. The proportioning device also comprises an outlet end connectable to an outlet conduit. Water can flow to the inlet and through the proportioning device exiting the outlet thereby creating a downstream water. The outlet end is connectable to the downstream water with the outlet conduit.

The main water-driven drive assembly is directly coupled to each of the respective fluid-fluid transferring devices, thus providing proportioned chemical feeds relative to the drive water flow.

The first, second, third, and optionally additional chemical inlet ports through which chemicals or compounds can be respectively drawn into and through the fluid transferring devices by individual conduits. Through the fluid transferring devices, the proportioning device comprises a first, a second, a third, and optionally additional chemical outlet ports through which the chemicals or compounds are respectively drawn to the downstream water by and through these individual conduits. The individual conduits can enter the downstream water at one or more locations, preferably at two or more locations or points.

Each fluid transferring device also comprises a metering piston.

The proportioning device can also comprise a piston actuator for reciprocally moving each metering piston within its respective fluid transferring device. The actuator can have an actuating fluid inlet and an actuating fluid outlet. The actuating fluid inlet can be connected to the conduit downstream of the inlet end. The actuating fluid outlet can be connected to the conduit upstream of the precursor chemical inlet ports therein. The actuator is generally responsive to a flow of water through the conduit to reciprocate each metering piston within its associated fluid transferring device thereby drawing a respective metered amount of precursor chemical from its source and to inject or introduce that metered amount of precursor chemical, which can be fixed or adjusted at the actuator, into the conduit through a chemical inlet port therein.

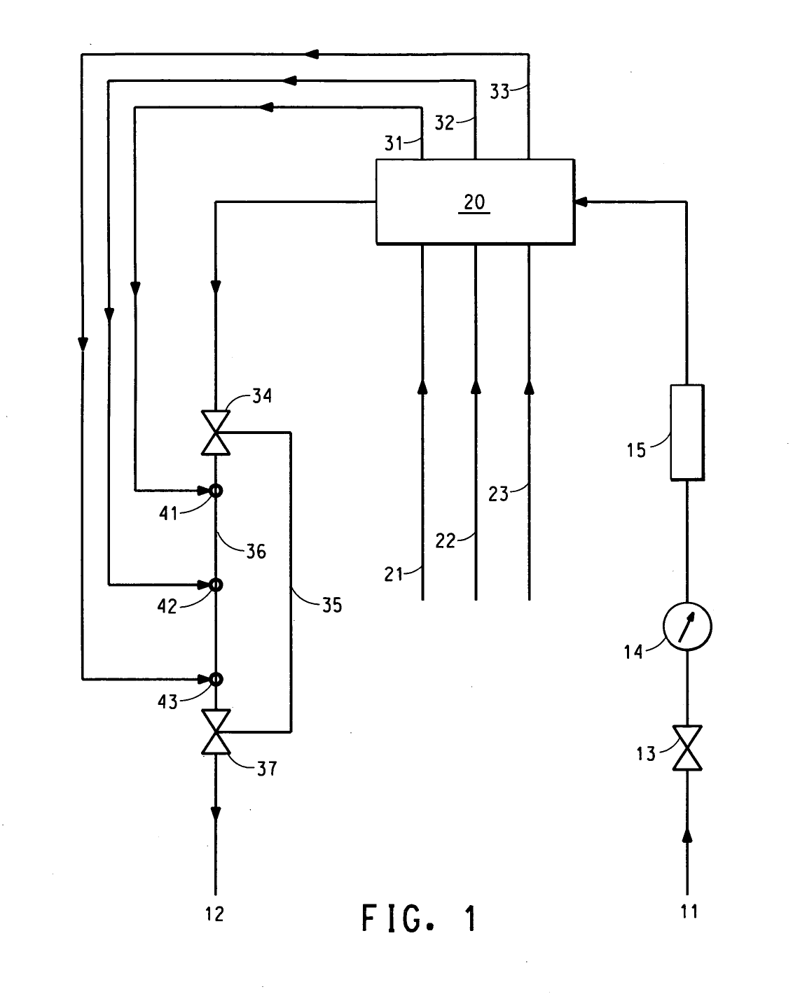

Referring to FIG. 1, a flow diagram of the apparatus is shown. The apparatus is illustrated herein with three fluid transferring devices, though more than three can be used for a variety of applications. Water flows through inlet 11, though valve 13 which controls the amount of water flow, preferred valve is a pressure regulating valve, pressure gauge 14, a flowmeter 15 measuring the quantity of water flow therethrough, and through a proportioning device 20, through which the water stream flows to outlet 12. Precursor chemicals such as, for example, a metal hypochlorite, a metal chlorite, and a mineral acid, as disclosed below, can be independently fed to and through lines or conduits 21, 22, and 23 to the fluid transferring devices of the proportioning device 20. The chemicals carried by conduits 21, 22, and 23 independently exit the fluid transferring devices of device 20 through conduits or conduits 31, 32, and 33. Conduits 31, 32, and 33 independently enter conduit 36. These conduits can be made from any suitable materials such as, for example, plastics and corrosion-resistant metals. Through control valves such as, for example, check valves, 41, 42, and 43, the chemicals that are useful for producing another chemical such as, for example, chlorine dioxide, can be carried by conduits 21, 22, and 23 reenter conduit 36 and can be diluted by the downstream water in conduit 36. Reaction takes place at where two or more precursor chemicals meet and chlorine dioxide can be produced in-situ forming an aqueous solution. Alternatively, the three or more precursor chemicals can be pre-reacted in a chamber or a conduit prior to injection or introduction into the downstream water conduit 36. Other means such as, for example, a solenoid, a modulating flow control valve or a pressure-regulating valve can be used in place of valve 13 to control the amount of water.

Proportioning device 20 can be any suitable device disclosed above and can be a pump. A preferred pump is a proportioning pump such as that disclosed in U.S. Pat. No. 4,572,229 or 5,433,240 with the exception that three or more slave cylinders disclosed in the patents are used herein as fluid transferring devices. Each fluid transferring device can be the same as that disclosed in U.S. Pat. No. 4,572,229 or 5,433,240 with the exception that additional cylinders having connecting rods are included in the proportioning device used herein. The entire disclosures of these patents are incorporated herein by reference. Other devices that can be used include those disclosed in U.S. Pat. Nos. 3,131,707; 3,114,379; 3,213,873; 3,213,796; and 3,291,066.

The drive water flowing through the apparatus can be variable within the hydraulic limitations of the device and in doing so can self proportion the chemicals transferred through each of the fluid transferring devices, thereby delivering consistent concentrations of individual precursor chemicals to be reacted to produce a desired chemical, at a consistent concentration, such as chlorine dioxide over the drive water flow range. That is, the concentration ratio of precursor chemicals can remain constant.

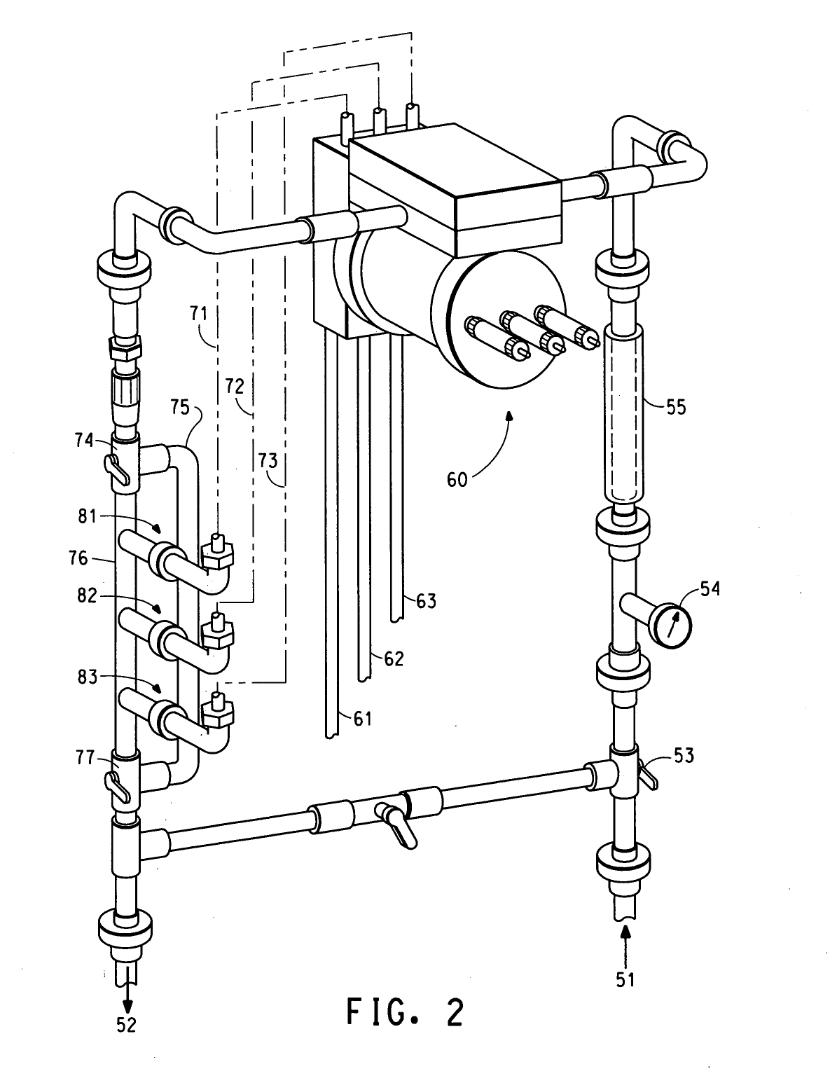

FIG. 2 illustrates an embodiment of the apparatus where inlet water (drive water) flows passing a local pressure gauge 54 and flow indicator 55. The water, under pressure, enters the proportioning pump 60. A proportioning device illustrated herein is a proportioning pump such as shown in reference numeral 60, which is commercially available from Crown Technology Corporation, Boise, Id. The term “proportioning” pump refers to a pump that proportionally mixes fluids by automatic, self-powered devices. The water can be considered “drive” water as it is used to drive the main internal piston assembly, as disclosed in U.S. Pat. Nos. 4,572,229 and 5,433,240, which is used to actuate the three individual pistons within the pump (fluid transferring devices or pump cylinders). As the fluid transferring device or cylinder pistons actuate back and forth, the individual chemicals are drawn in from conduits 61, 62, and 63 and then displaced out of the pump cylinder chambers each complete piston cycle. The volume of each pump cylinder chamber can be fixed but is adjustable using an external chemical feed adjustment dial (reference numerals 64, 65, and 66). As water flow varies through the pump drive assembly, the frequency of piston actuation remains proportional to the water flow. This remains proportional, each of the precursor chemicals feeds proportionally to the varying flow thus providing constant chemical concentration in the water outlet. The safety benefit in the mode of operation is that if water flow to the pump stops, so does the injection or introduction of precursor chemicals.

As the drive water exits the pump, it passes an in-line check valve (reference numerals 81, 82, and 83). Following this check valve are three individual chemical injection points. Optionally these three precursor chemicals can be injected or introduced simultaneously at one injection point. As each pump cycle is completed, the proportioned chemicals leaving the fluid transferring devices can be injected or introduced into each of these points (under pressure provided by the displacement portion of the piston cycle) or at the same point. Once injected or introduced, these precursor chemicals can be immediately diluted by the drive water that has passed through the proportioning device or pump. Once two or more precursor chemicals have been injected or introduced, they combine in-stream and react to form the desired product such as, for example, dilute solution of chlorine dioxide (ClO₂) as disclosed below.

Alternatively, a portion of water can be diverted to by-pass conduit 35 or 75. Valve 34 or 74 can be used to control the amount of water going through conduit 36 or 76 that is used to dilute chemicals exiting from proportioning device 20 or 60 via conduits 31, 32, and 33 (71, 72, and 73 in FIG. 2) entering the water stream at 41, 42, and 43 (81, 82, and 83 in FIG. 2). Water diverted through conduit 35 or 75 reenters conduit 36 or 76 downstream. There are ways to react more concentrated precursor chemicals. For example, rather than simply injecting or introducing the precursor chemicals into the drive water stream (down-stream of the pump), the precursor chemicals can be pre-reacted in a small chamber just prior to further dilution in the drive water.

Examples of compounds that can be produced include, but are not limited to, chlorine dioxide, bromine dioxide, hypochlorous acid, hypobromous acid, hypochlorites, hypobromites, chlorous acid, acidified sodium chlorite, and combinations of two or more thereof.

The process can also comprise introducing a water flow to and through an apparatus disclosed above to produce a downstream water; feeding three or more precursor chemicals at a proportional rate to each other to and through the apparatus; and combining the precursor chemicals with the downstream water wherein the water flow is used as a motive force for proportionally feeding the precursor chemicals to and through the apparatus at a rate relative to the water flow whereby a chemical reaction occurs between two or more of the precursor chemicals.

The process can also comprise (a) flowing water through a fluid proportioning device, which can be as the one disclosed above to create a downstream water and to actuate the fluid transferring devices; (b) drawing three or more chemicals each from a separate source and flowing each of the chemicals separately through one of the fluid transferring devices; and (c) injecting or introducing the chemicals into the downstream water whereby a chemical reaction occurs between two or more of the precursor chemicals.

A chemical product such as chlorine dioxide in water can be transferred to a holding tank or to its ultimate end use, for example, a municipal water treatment plant or the treatment of waste in a sewage plant. A calorimeter can be used to monitor the chlorine dioxide concentration, if desired. The solution can also be monitored by pH meter and the pH can be accordingly adjusted to about 2.0-10, or about 4-6, by any means known to one skilled in the art. Alternative means of monitoring include ORP (oxidation reduction potential), residual monitors, and spectrophotometric analyzers.

The process can also comprise flowing water to produce a downstream water; and feeding into the downstream water three or more precursor chemicals at a rate relative to the flow of the water and at proportional rates to each other thereby producing the animal drinking water. The term “animal” refers to all animals known to one skilled in the art and can include, but are not limited to, chicken, turkey, duck, goose, calf, cow, swine, fish, and other farm animals.

### EXAMPLES

The following examples are provided to illustrate the invention and are not to be construed as to unduly limit the scope of the invention.

### Example 1

Potable water was fed to an apparatus through a filter to remove particulate. A water booster pump was used to generate test pressures above available potable water line pressure. The apparatus including a triple headed hydraulic metering pump as shown in FIG. 2, with the exception that injection points 81 and 82 were relatively close and that a static mixer was placed between reference numerals 82 and 83, was used to convey and inject precursor chemicals (precursor chemicals described below). The ratio of the flow rates of the precursor chemicals to each other and to the motive water flow were manipulated by adjusting the stroke length on each of the three chemical dosing cylinders on the pump. Sodium chlorite, sodium hypochlorite, and hydrochloric acid were employed as chemicals for producing animal drinking water. The motive water inlet pressure was adjusted to vary the chlorine dioxide concentration in the downstream water. Two samples were taken at 1.5 US gallons per minute (GPM), four at 3.0 GPM and two at 6.0 GPM. This represented a chlorine dioxide production rate of 35 to 142 pounds (15.9 to 64.5 kg) per day ClO₂. Excess chlorine as defined in EPA Guidance Manual: Alternative Disinfectants and Oxidants, EPA, April 1999, page 4-3, was measured at less than 0.1%. This represents an extremely low excess chlorine concentration. Chlorine dioxide concentration was measured from 1940 to 2010 mg/l with a mean of 1974 mg/l. Chlorite ion concentration was measured from 1.0 mg/l to 6.1 mg/l, with a mean of 3.3 mg/l. Chlorate ion concentration was measured from 118 mg/l to 145 mg/l, with a mean of 132 mg/l. The efficiency as measured by spectrophotometry and ion chromatography varied from 99.7% to 99.9% with a mean of 99.8%.

### Example 2

This example illustrates using a solution produced by the invention for chicken drinking water.

Broiler chickens raised on a northeast Texas commercial chicken farm were used for the study. A typical chicken farm comprised about 10 to 12 chicken houses each had about 15,000 chickens. All broilers for the runs (test flock and the control flock) came from the same genetic stock. Water was fed to the chickens at a rate of about 2 gallons (7.57 liters) per minute. All water lines, about 1/8 inch (0.32 cm) diameter, for feeding the chickens were first cleaned with adequate Biosentry Aqua Max® cleaning solution, according to the manufacturer's instruction. On control runs, regular tap water was used to feed the chickens. For experimental runs, water flowed through the apparatus disclosed above before entering the chicken houses. Sodium chlorite, sodium hypochlorite, and phosphoric acid were each withdrawn from the inlets of the apparatus. Sodium chlorite and sodium hypochlorite were used to disinfect the water lines and phosphoric acid was used to adjust pH to the range of about 4 to about 6. The quantity of each chemical required was the quantity that maintained the pH of the water at the above-disclosed pH, or about 3-10 parts per million (by weight; ppm) of free chlorine in the water, or about 0.5 to about 0.8 ppm of chlorine dioxide produced in-situ in the water, or the quantity that controlled the formation of biofilm in the water pipes or conduits. All chickens were fed with the same commercially available feed typically for 50 days. The fatality of chickens fed with water generated by the invention and tap water was then determined. It was found that the test flock had 96.69% livability at the end of the growing cycle compared to 94.58% for the control flock. Additionally, the test flock had a 1.89 feed conversion compared to 1.93 for the control flock. The lower feed conversion means less feed was required to achieve the same chicken weight. The results demonstrate that the drinking water produced by the invention not only increased the survival rate of chickens but also improved the feed conversion.

1. A process for producing animal drinking water comprising (a) flowing water through a fluid proportioning device, which comprises three or more fluid transferring devices, to create a downstream water and to actuate said transferring devices wherein said proportioning device comprises a water inlet; a water outlet; a main water-driven drive assembly; and a first, a second, a third, and optionally additionally transferring devices; (b) drawing first chemical, second chemical, third chemical, and optionally additional chemicals each from a separate source and flowing each said chemical separately through one of said transferring devices; and (c) combining said first chemical, said second chemical, said third chemical, and said optional additional chemicals with said downstream water to produce said drinking water wherein said water inlet is connectable to a water source; said transferring device comprises a transferring device inlet and a transferring device outlet, each being connectable to a conduit;
said water source is capable of producing a water flow into and through said main water-driven drive assembly thereby producing said downstream water through said water outlet; and
each of said transferring devices is proportionally actuated by said water flow thereby withdrawing through said first, second, third, and optionally additional transferring devices said first chemical, said second chemical, said third chemical, and said optional additional chemicals are respectively drawn in a proportional amount dependent on the flow rate of said water flow and discharging said first chemical, said second chemical, said third chemical, and said optional additional chemicals to said downstream water with or without prior mixing of said chemicals.

2. A process according to claim 1 wherein each of said transferring device comprises an inlet port, an outlet port, and a metering piston therein; said proportioning device comprises a piston actuator comprising an actuating inlet and an actuating fluid outlet; and said actuator reciprocally moves said metering piston within said transferring device.

3. A process according to claim 2 wherein said combining produces a product, which is chlorine dioxide, acidified chlorite, chlorous acid, or combinations thereof.

4. A process according to claim 3 wherein said product is chlorine dioxide.

5. A process according to claim 2 wherein said first chemical is metal chlorite, said second chemical is metal hypochlorite, and said third chemical is acid.

6. A process according to claim 5 wherein said first chemical is sodium chlorite, potassium chlorite, or both; said second chemical is sodium hypochlorite, potassium hypochlorite, or both; and said third chemical is phosphoric acid.

7. A process according to claim 4 wherein said first chemical is metal chlorite, said second chemical is metal hypochlorite, and said third chemical is acid.

8. A process according to claim 7 wherein said first chemical is sodium chlorite, potassium chlorite, or both; said second chemical is sodium hypochlorite, potassium hypochlorite, or both; and said third chemical is phosphoric acid.

9. A process according to claim 8 wherein said first chemical is sodium chlorite and said second chemical is sodium hypochlorite.

10. A process according to claim 9 wherein said animal is chicken.

11. A process for producing chicken drinking water comprising flowing water through a single fluid proportioning device to produce a downstream water; and feeding into said downstream water a metal chlorite, a metal hypochlorite, and an acid each at a rate relative to the flow of said water and at proportional rates to each other wherein said proportioning device is the same as recited in claim 1 and said flowing water provides a motive force for proportionally feeding said chemicals to said downstream water;

12. A process according to claim 11 wherein said proportioning device comprises an inlet port, an outlet port, and a metering piston therein; said proportioning device comprises a piston actuator comprising an actuating inlet and an actuating fluid outlet; and said actuator reciprocally moves said metering piston within said transferring device; and through said transferring device said metal chlorite, said metal hypochlorite, and said acid are respectively withdrawn in a proportional amount dependent on the flow rate of said water flow and discharging said metal chlorite, said metal hypochlorite, and said acid to said downstream water with or without prior mixing of said metal chlorite, said metal hypochlorite, and said acid.

13. A process according to claim 12 wherein said acid is phosphoric acid.

14. A process according to claim 12 wherein said metal chlorite is sodium chlorite, potassium chlorite, or both.

15. A process according to claim 13 wherein said metal chlorite is sodium chlorite, potassium chlorite, or both.

16. A process according to claim 15 wherein said metal chlorite is sodium chlorite.

17. A process according to claim 12 wherein said metal hypochlorite is sodium hypochlorite, potassium hypochlorite, or both.

18. A process according to claim 13 wherein said metal hypochlorite is sodium hypochlorite, potassium hypochlorite, or both.

19. A process according to claim 14 wherein said metal hypochlorite is sodium hypochlorite, potassium hypochlorite, or both.

20. A process according to claim 15 wherein said metal hypochlorite is sodium hypochlorite, potassium hypochlorite, or both.

21. A process according to claim 16 wherein said metal hypochlorite is sodium hypochlorite.

22. A process for producing chicken drinking water comprising flowing water through a single fluid proportioning device to produce a downstream water; and feeding into said downstream water sodium chlorite, sodium hypochlorite, and phosphoric acid each at a rate relative to the flow of said water and at proportional rates to each other wherein said proportioning device is the same as recited in claim 2 and said flowing water provides a motive force for proportionally feeding said chemicals to said downstream water;

23. A process according to claim 22 wherein the pH of said drinking water is about 4 to about 6.
